(19) United States
(12) Patent Application Publication
(10) Pub. No.: US 2026/0091468 A1
(43) Pub. Date: Apr. 2, 2026

(54) ANGULARLY ADJUSTABLE VISE

(71) Applicant: DURQ MACHINERY CORP., TAICHUNG CITY (TW)

(72) Inventors: Chia-Sheng LIU, TAICHUNG CITY (TW); Chieh-Yuan TSAI, TAICHUNG CITY (TW); Yue-Hsun LIN, TAICHUNG CITY (TW)

(21) Appl. No.: 18/999,477

(22) Filed: Dec. 23, 2024

(30) Foreign Application Priority Data
Sep. 30, 2024 (TW) 113137304

(51) Int. Cl. B25B 1/22

(52) U.S. Cl. CPC B25B 1/22

(57) ABSTRACT

An angularly adjustable vise includes a base, a first jaw disposed on the base, a moving device including a linearly moving member disposed on the base and a shaft movable along with the linearly moving member, a second jaw sleeved onto the shaft rotatably relative to the shaft, and a restricting device including a restricting member disposed on the second jaw changeably between a restricting position and a release position. When the restricting member is at the restricting position, a part thereof is connected with the moving device so that the rotation of the restricting member and the second jaw is restricted by the moving device. When the restricting member is at the release position, the part thereof is separated from the moving device. Therefore, the second jaw is able to be set rotatable freely or rotationally restricted, achieving great clamping effect under different usage conditions.

### BACKGROUND OF THE INVENTION

### Field of the Invention

The present invention relates generally to vises and more particularly, to an angularly adjustable vise.

### Description of the Related Art

The conventional vise primarily includes a base, and a first jaw, a second jaw and a threaded rod, which are disposed on the base. The first jaw is fixed on the base. The threaded rod can be rotated by the user. The second jaw can be driven by the threaded rod to approach or leave the first jaw. When the vise is in use, the base thereof is fixed on a workbench or a worktable of a machine tool. The user places a workpiece between the first jaw and the second jaw and rotates the threaded rod to move the second jaw toward the first jaw, so as to fixedly clamp the workpiece by the first and second jaws.

In order to meet different requirements in workpiece setting angle, some vises are adapted for the user to adjust the angle of the first jaw before fix it to the base, and the second jaw is configured being rotatable freely relative to the threaded rod. As long as the user rotates the threaded rod to push the second jaw toward the workpiece, the second jaw will automatically rotate in coordination with the angle of the workpiece surface in contact with the second jaw, so as to be firmly abutted on the workpiece surface, making the workpiece fixedly clamped by the first and second jaws.

However, in the condition that the workpiece is relatively shorter in length, such as that the workpiece is shorter in length than the clamping surface of the second jaw, the second jaw is liable to rotate in the wrong direction when contacting a corner of the workpiece. For example, the second jaw may be supposed to rotate counterclockwise and thereby abutted on the workpiece surface supposed to be clamped, but rotate clockwise because of contacting a corner of the workpiece. In other words, in the condition that the workpiece is relatively shorter in length, the second jaw is liable to be disabled by its own rotatable characteristic from clamping the workpiece normally, or the clamping manner thereof may cause the user uneasy to perform a cutting process to the workpiece and may even cause the second jaw cut.

### SUMMARY OF THE INVENTION

The present invention has been accomplished in view of the above-noted circumstances. It is an objective of the present invention to provide an angularly adjustable vise which is adapted for the user to set the jaw in the freely rotatable status or restrict the jaw to a specific angle or angle range, so as to achieve great clamping effect under different workpiece setting angles and different workpiece lengths.

To attain the above objective, the present invention provides an angularly adjustable vise which includes a base, a first jaw disposed on the base, a moving device, a second jaw, and a restricting device. The moving device includes a linearly moving member and a shaft. The linearly moving member is disposed on the base movably by being operated by a user. The shaft is disposed on the linearly moving member movably along with the linearly moving member. The shaft includes an upper surface, and a restricting recess recessed from the upper surface. The second jaw is sleeved onto the shaft rotatably relative to the shaft. The second jaw includes an axial hole, and an installation recess located at an end of the axial hole. The shaft is disposed in the axial hole. The restricting device includes a restricting member, a bolt, and an elastic member. The restricting member includes an upper restricting portion, a lower restricting portion, and a through hole. The restricting member is disposed in the installation recess in a way that the rotation of the second jaw is restricted by the restricting member. The bolt includes a head portion disposed on the upper restricting portion, and a rod portion inserted through the through hole. The rod portion includes a threaded section. The threaded section is screwed into a threaded hole in the shaft. The elastic member is disposed between the shaft and the restricting member in a way that the restricting member is pushed toward the head portion of the bolt by the elastic member. The bolt is movable relative to the shaft by being rotated by the user, so as to make the restricting member moved between a restricting position and a release position. When the restricting member is located at the restricting position, the lower restricting portion is located in the restricting recess of the shaft to cause the rotation of the restricting member and the second jaw restricted by the restricting recess. When the restricting member is located at the release position, the restricting member is pushed by the elastic member to make the lower restricting portion leave the restricting recess.

As a result, in the condition that the user wants to set the second jaw in the freely rotatable status, such as the condition that the length of the workpiece is larger than the length of the clamping surface of the second jaw, the user can rotate the bolt of the restricting device to set the bolt in a relatively looser screwed status, so as to locate the restricting member at the release position. In this status, the lower restricting portion of the restricting member is not located in the restricting recess of the shaft, so the rotation of the restricting member and the second jaw is not restricted by the restricting recess. The second jaw is freely rotatable relative to the shaft, which means it can automatically rotate in coordination with the angle of the workpiece surface in contact with the second jaw, so as to be firmly abutted on the workpiece surface, making the workpiece fixedly clamped by the first and second jaws. In the condition that the user wants to restrict the second jaw to a specific angle or angle range, such as the condition that the workpiece is shorter in length than the clamping surface of the second jaw, the user firstly sets the second jaw in the freely rotatable status, then adjusts the second jaw to the required angle, and then screwingly tightens the bolt to locate the restricting member at the restricting position. In this status, the lower restricting portion of the restricting member is located in the restricting recess of the shaft so that the rotation of the restricting member and the second jaw is restricted by the restricting recess. That means the restricting member and the second jaw cannot rotate or can only rotate in a small angle range, such that the second jaw is prevented from rotating in the wrong direction when contacting a corner of the workpiece, so the first and second jaws will be at the required angle when clamping the workpiece and thereby achieve great clamping effect.

To attain the above objective, besides using the above-described structure to change the status of the second jaw between the freely rotatable status and the rotationally restricted status, the present invention can use other structures to achieve the same effect.

The present invention provides an angularly adjustable vise which includes a base, a first jaw disposed on the base, a moving device, a second jaw, and a restricting device. The moving device includes a linearly moving member and a shaft. The linearly moving member is disposed on the base movably by being operated by a user. The shaft is disposed on the linearly moving member movably along with the linearly moving member. The second jaw is disposed on the shaft rotatably relative to the shaft. The restricting device includes a restricting member. The restricting member is disposed on the second jaw in a way that the position of the restricting member is changeable between a restricting position and a release position. When the restricting member is located at the restricting position, a part of the restricting member is connected with the moving device so that the rotation of the restricting member and the second jaw is restricted by the moving device. When the restricting member is located at the release position, the aforementioned part of the restricting member is separated from the moving device.

As a result, the user, according to the usage requirement thereof, can change the position of the restricting member to the release position to make the second jaw rotatable freely, or change the position of the restricting member to the restricting position to restrict the second jaw to a specific angle or angle range, so that great clamping effect can be achieved under different workpiece setting angles and different workpiece lengths.

For example, the aforementioned part of the restricting member may be the above-described lower restricting portion. Alternatively, the restricting device may be the structure described below.

The present invention provides another type of restricting device, which is a transversely moving type restricting device, and the restricting member thereof is a transversely moving type restricting member. When rotating relative to the shaft, the second jaw rotates around an imaginary vertical axis. The transversely moving type restricting member includes an elongated installation groove extending into a long shape perpendicularly to the imaginary vertical axis, and at least one stopping sheet extending from at least one side of the elongated installation groove. An end portion of the linearly moving member is inserted in the elongated installation groove. When the position of the transversely moving type restricting member is changed between the restricting position and the release position, the end portion of the linearly moving member slides along the elongated installation groove. When the transversely moving type restricting member is located at the restricting position, the stopping sheet is abutted against the end portion of the linearly moving member to restrict the transversely moving type restricting member and the second jaw from rotating in a specific direction. When the transversely moving type restricting member is located at the release position, the stopping sheet is separated from the end portion of the linearly moving member. In other words, for this structure, the aforementioned part of the restricting member is the stopping sheet.

As a result, the user can firstly adjust the transversely moving type restricting member to the required position in a way that the end portion of the linearly moving member slides along the elongated installation groove, and then fix the transversely moving type restricting member to the second jaw. For example, when the user wants to restrict the second jaw from rotating in the specific direction, the user only has to dispose the transversely moving type restricting member on the second jaw at the restricting position to make the stopping sheet abutted against the end portion of the linearly moving member, so that the second jaw is stopped by the stopping sheet from rotating in the specific direction. When the user wants to set the second jaw in the freely rotatable status, the user only has to dispose the transversely moving type restricting member on the second jaw at the release position to make the rotation of the second jaw unrestricted by the stopping sheet. The user can dispose the transversely moving type restricting member on the second jaw at any position between the restricting position and the release position to make the transversely moving type the restricting member and the second jaw still rotatable slightly in the specific direction. In this way, the angularly adjustable vise can achieve great clamping effect under different usage requirements.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is an assembled perspective view of an angularly adjustable vise according to a preferred embodiment of the present invention.

FIG. 2 is an exploded perspective view of partial components of the angularly adjustable vise.

FIG. 3 is an exploded perspective view of a second jaw, a transversely moving type restricting device and a linearly moving member of the angularly adjustable vise.

FIG. 4 is an exploded perspective view of another restricting device and a shaft of the angularly adjustable vise.

FIG. 5 is a perspective view of a restricting member of the restricting device shown in FIG. 4.

FIG. 6 is a top view of the partial components of the angularly adjustable vise shown in FIG. 2.

FIG. 7 is a sectional view taken along the line 7-7 in FIG. 6, showing that the restricting member is located at a restricting position.

FIG. 8 is similar to FIG. 7, but showing that the restricting member is located at a release position.

FIG. 9 is a transversely sectional view of the partial components of the angularly adjustable vise shown in FIG. 2, showing that a transversely moving type restricting member of the transversely moving type restricting device is located at a restricting position.

FIG. 10 is similar to FIG. 9, but showing that the transversely moving type restricting member is located at a release position.

FIG. 11 is similar to FIG. 9, but showing that the transversely moving type restricting member is located at another restricting position.

FIGS. 12 and 13 are top views of the angularly adjustable vise and a workpiece, showing different usage statuses respectively.

### DETAILED DESCRIPTION OF THE INVENTION

First of all, it is to be mentioned that same or similar reference numerals used in the following embodiment and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

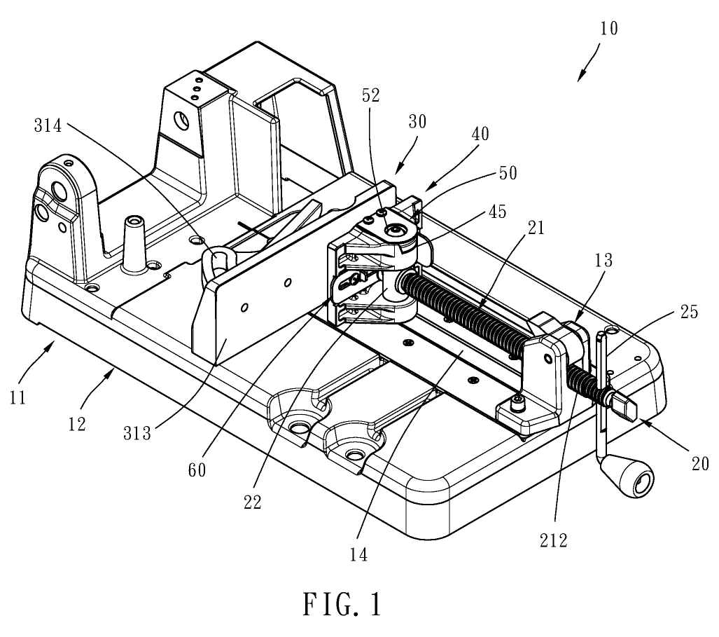

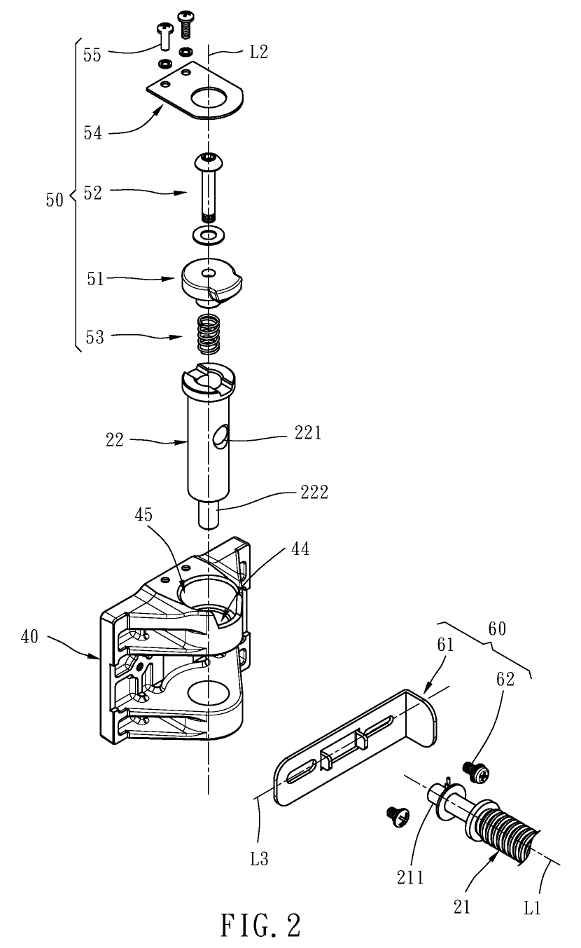

Referring to FIG. 1 and FIG. 2, an angularly adjustable vise 10 according to a preferred embodiment of the present invention includes a base 11, a moving device 20, a first jaw 30 and a second jaw 40, which are disposed on the base 11, and two restricting devices disposed on the second jaw 40.

It should be firstly mentioned here that the moving device 20 primarily includes a linearly moving member 21 disposed on the base 11 along an imaginary horizontal axis L1, and a shaft 22 disposed on the linearly moving member 21 along an imaginary vertical axis L2. The two restricting devices in this embodiment include a restricting device 50 disposed in the shaft 22 along the imaginary vertical axis L2, and a transversely moving type restricting device 60 disposed on an end portion 211 of the linearly moving member 21. The angularly adjustable vise 10 may use only one of the restricting device 50 and the transversely moving type restricting device 60, or may use both the restricting device 50 and the transversely moving type restricting device 60 at the same time. The structure of them will be specified hereinafter. The linearly moving member 21 used in this embodiment is a threaded rod for being rotated by the user to move linearly. However, the linearly moving member in the present invention may be a piston rod of a hydraulic cylinder or pneumatic cylinder, or other components able to be operated by the user to move linearly.

The base 11 primarily includes a main body 12 approximately shaped as a rectangular plate, and a threaded rod seat 13 fixed on the main body 12 and located adjacent to one side thereof. The main body 12 has a groove 14 extending from a position adjacent to the threaded rod seat 13 toward another side of the main body 12.

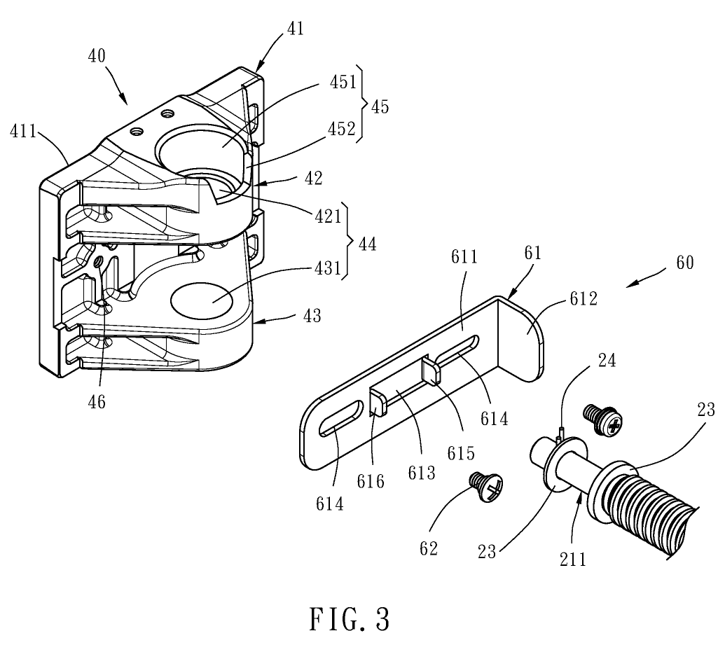

The linearly moving member (threaded rod) 21 is screwed through the threaded rod seat 13, disposed above the groove 14 of the base 11 and parallel to the groove 14. The end portion 211 of the linearly moving member 21 is rotatably inserted through a through hole 221 of the shaft 22. Two positioning sheets 23 are sleeved onto the end portion 211 of the linearly moving member 21, and a positioning pin 24 is inserted through the end portion 211, as shown in FIG. 3. The shaft 22 is positioned between the positioning sheets 23 by the positioning sheets 23, so that the shaft 22 is disabled from separating from the end portion 211 of the linearly moving member 21. A bottom section 222 of the shaft 22 is inserted into the groove 14 of the base 11. A lever 25 is inserted through a front end portion 212 of the linearly moving member 21. When a user holds the lever 25 to rotate the linearly moving member 21, the linearly moving member 21 is linearly moved relative to the base 11 along the imaginary horizontal axis L1. At the same time, the shaft 22 is also moved along with the linearly moving member 21, and the bottom section 222 of the shaft 22 slides along the groove 14 of the base 11.

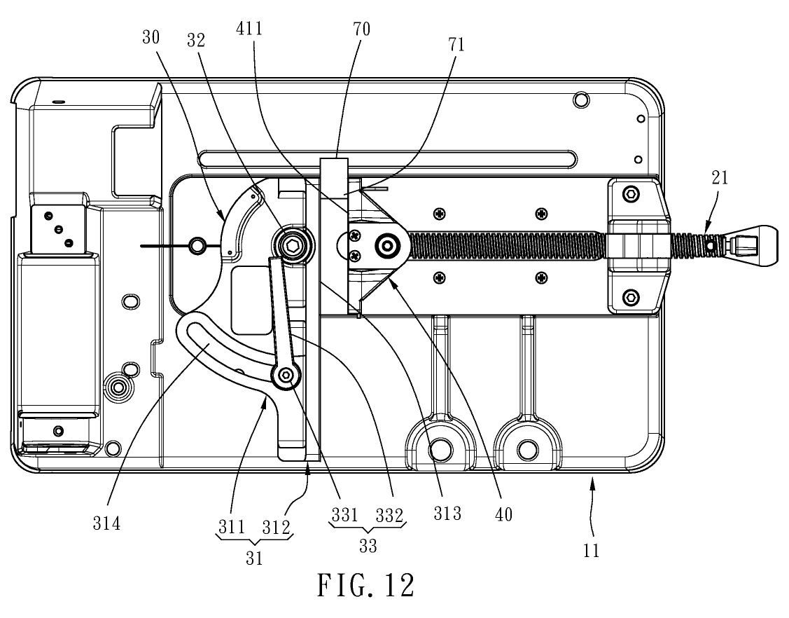

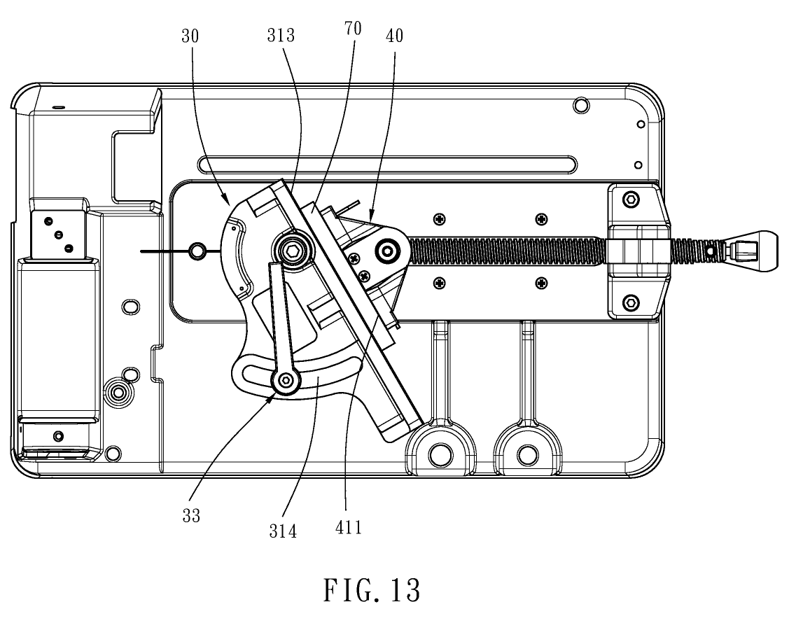

Referring to FIG. 1, FIGS. 12 and 13, the first jaw 30 in this embodiment includes a main body 31, a rotation axle 32 inserted through the main body 31 and the base 11, and an adjusting member 33. The main body 31 includes a horizontal portion 311, and a vertical portion 312 integrally connected to one side of the horizontal portion 311. The vertical portion 312 has a clamping surface 313 facing toward the moving device 20 and the second jaw 40. The horizontal portion 311 has an arc groove 314. The adjusting member 33 includes a central axle 331, and a lever 332 sleeved onto the central axle 331. The central axle 331 is inserted through the arc groove 314 and the base 11. The lever 332 can be rotated by the user to tighten and loosen the adjusting member 33. When the adjusting member 33 is loosened, the main body 31 can be rotated by the user in a way that the adjusting member 33 slides in the arc groove 314, such as being rotated from the status as shown in FIG. 12 to the status as shown in FIG. 13. When the adjusting member 33 is tightened, the main body 31 is fixed to the base 11, such that the direction the clamping surface 313 of the first jaw 30 faces toward is fixed.

It should be mentioned here that the first jaw 30 in this embodiment is the type adapted to be rotated by the user for angle adjustment, but the first jaw in the present invention is unlimited to the configuration provided in this embodiment. For example, the first jaw may be the type unable to be rotated by the user for angle adjustment, or the first jaw may be angularly adjustable in other manners.

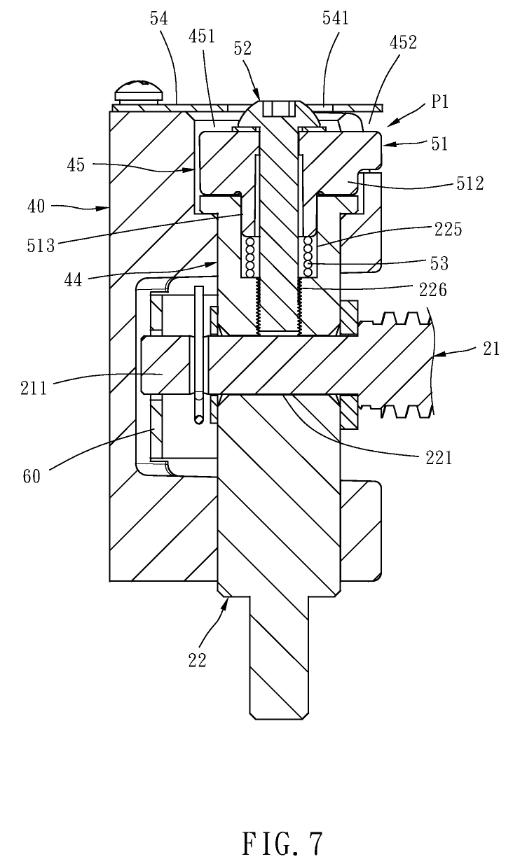

Referring to FIG. 3, the second jaw 40 includes a clamping portion 41 shaped as a vertical plate, and an upper installation portion 42 and a lower installation portion 43, which integrally extend from one side of the clamping portion 41. The clamping portion 41 has a clamping surface 411 for a workpiece 70 to be clamped by the clamping surface 411 and the clamping surface 313 of the first jaw 30 together, as shown in FIGS. 12 and 13. The upper installation portion 42 and the lower installation portion 43 have circular through holes 421 and 431 respectively. The through holes 421 and 431 are sized equally and coaxial with each other, collectively composing an axial hole 44 for disposing the shaft 22. As shown in FIGS. 2 and 7, the shaft 22 is disposed in the axial hole 44 so that the second jaw 40 is sleeved onto the shaft 22 rotatably relative to the shaft 22. In other words, the second jaw 40 is rotatable around the imaginary vertical axis L2 relative to the shaft 22.

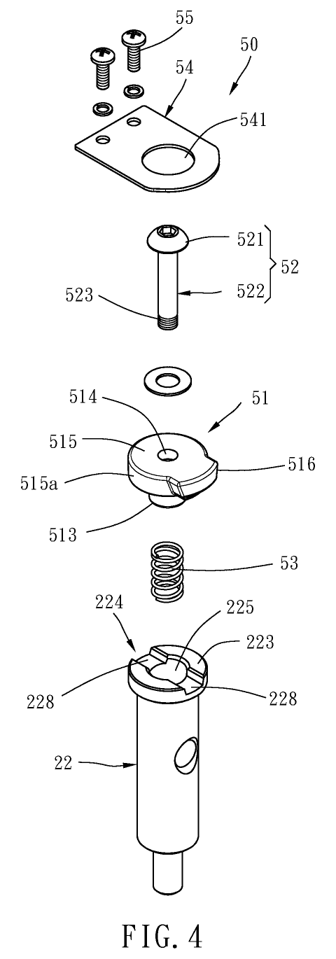

As described above, the angularly adjustable vise 10 may include at least one of the restricting device 50 and the transversely moving type restricting device 60. In the condition that the angularly adjustable vise 10 includes the restricting device 50, the shaft 22 includes a restricting recess 224 recessed from an upper surface 223 of the shaft 22, as shown in FIG. 4, and the second jaw 40 has an installation recess 45 located at an end of the axial hole 44, as shown in FIG. 3. The installation recess 45 is located at the upper end of the through hole 421 of the upper installation portion 42.

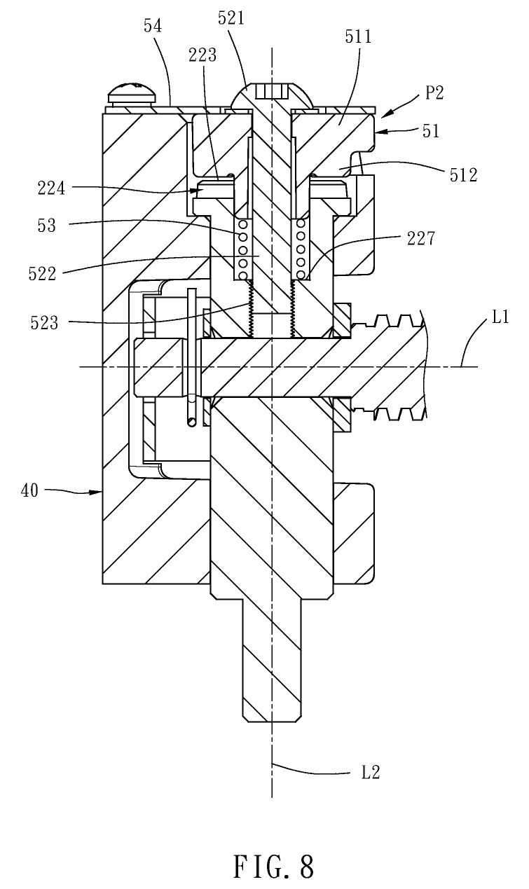

Specifically speaking, the shaft 22 includes an accommodating hole 225 extending downwardly from the upper surface 223 as shown in FIG. 4, and a threaded hole 226 extending downwardly from the accommodating hole 225 as shown in FIG. 7. The accommodating hole 225 has a supporting surface 227 connected with the threaded hole 226, as shown in FIG. 8. In other words, the threaded hole 226 extends downwardly from the supporting surface 227. As shown in FIG. 4, the restricting recess 224 of the shaft 22 includes two sections 228 extending from two opposite sides of the accommodating hole 225. As shown in FIG. 3, the installation recess 45 of the second jaw 40 includes a circular hole 451, and a lateral groove 452 located on a side of the circular hole 451 and communicating with the circular hole 451.

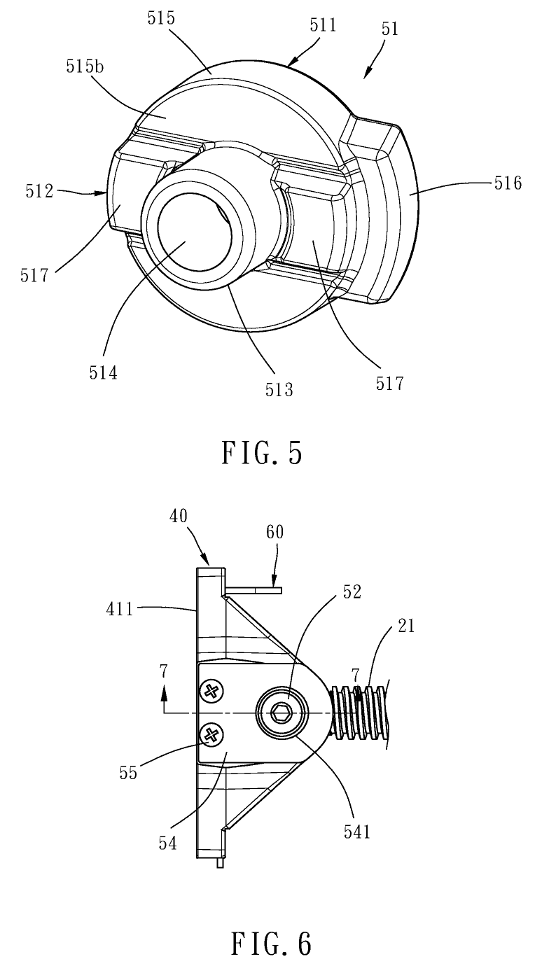

Referring to FIGS. 4 and 5, the restricting device 50 primarily includes a restricting member 51, a bolt 52, and an elastic member 53. The restricting member 51 includes an upper restricting portion 511, a lower restricting portion 512, an axle portion 513, and a through hole 514. The upper restricting portion 511 includes a circular section 515, and a lateral protrusion 516 extending from a periphery 515a of the circular section 515. The axle portion 513 extends from the center of a lower surface 515b of the circular section 515 of the upper restricting portion 511. The through hole 514 penetrates through the circular section 515 and the axle portion 513. The lower restricting portion 512 includes two protrusions 517 extending from the lower surface 515b of the circular section 515 of the upper restricting portion 511. The two protrusions 517 are located on two opposite sides of the axle portion 513, and one of the protrusions 517 is connected with the lateral protrusion 516 of the upper restricting portion 511. The bolt 52 includes a head portion 521 and a rod portion 522. The rod portion 522 includes a threaded section 523. The rod portion 522 is inserted through the through hole 514 of the restricting member 51. As shown in FIGS. 7 and 8, the head portion 521 of the bolt 52 is disposed on the upper restricting portion 511 of the restricting member 51. The threaded section 523 of the bolt 52 is located below the axle portion 513 of the restricting member 51. The elastic member 53 is a compression spring sleeved onto the rod portion 522 of the bolt 52 and disposed in the accommodating hole 225 of the shaft 22. The rod portion 522 of the bolt 52 is inserted through the accommodating hole 225. The restricting member 51 is disposed in the installation recess 45 in a way that the circular section 515 and the lateral protrusion 516 of the upper restricting portion 511 are located in the circular hole 451 and the lateral groove 452 of the installation recess 45 of the second jaw 40 respectively. The axle portion 513 of the restricting member 51 is inserted in the accommodating hole 225 of the shaft 22. Two ends of the elastic member 53 are disposed on the supporting surface 227 of the shaft 22 and the axle portion 513 of the restricting member 51 respectively. The threaded section 523 of the bolt 52 is screwed into the threaded hole 226 in the shaft 22 so that the elastic member 53 will be compressed to different content with the rotation of the bolt 52. That means the elastic member 53 is disposed between the shaft 22 and the restricting member 51 in a way that the restricting member 51 is pushed toward the head portion 521 of the bolt 52 by the elastic member 53.

By the above-described shape design of the upper restricting portion 511 of the restricting member 51 and the installation recess 45 of the second jaw 40, the rotation of the second jaw 40 is restricted by the restricting member 51. When it is mentioned in the present invention that the rotation is restricted, it means inability to rotate or ability to rotate in a small angle range only. In this embodiment, the upper restricting portion 511 of the restricting member 51 and the installation recess 45 of the second jaw 40 are complementary in shape to each other, so that the upper restricting portion 511 is disposed in the installation recess 45 in a way that their shapes exactly match. In this way, the second jaw 40 is disabled from rotating relative to the restricting member 51. However, the upper restricting portion 511 of the restricting member 51 and the installation recess 45 of the second jaw 40 may be configured being not completely complementary in shape to each other. For example, the lateral groove 452 of the installation recess 45 may be a little wider than the lateral protrusion 516 of the upper restricting portion 511 to enable the lateral protrusion 516 to slightly move in the lateral groove 452, so that the second jaw 40 is rotatable relative to the restricting member 51 in a small angle range. Such situation is also included when it is mentioned in the present invention that the rotation is restricted. The shape design of the upper restricting portion 511 of the restricting member 51 and the installation recess 45 of the second jaw 40 is unlimited to that provided in this embodiment, as long as it brings the above-described rotation restricting effect. However, the design in this embodiment has the advantages of being simple in structure and easy in manufacture and assembly.

As shown in FIGS. 7 and 8, the bolt 52 of the restricting device 50 can be rotated by the user, thereby moving relative to the shaft 22 upwardly and downwardly along the imaginary vertical axis L2. Because the elastic member 53 pushes the restricting member 51 toward the head portion 521 of the bolt 52, the restricting member 51 is moved between a restricting position P1 and a release position P2 along with the bolt 52 being rotated by the user. When the restricting member 51 is located at the restricting position P1, the lower restricting portion 512 of the restricting member 51 is located in the restricting recess 224 of the shaft 22. Specifically speaking, the two protrusions 517 of the lower restricting portion 512 (as shown in FIG. 5) are located in the two sections 228 of the restricting recess 224 (as shown in FIG. 4) respectively, so that the rotation of the restricting member 51 is restricted by the restricting recess 224. Because the rotation of the second jaw 40 is restricted by the restricting member 51, the rotation of the second jaw 40 is also restricted by the restricting recess 224. In this embodiment, the lower restricting portion 512 of the restricting member 51 and the restricting recess 224 of the shaft 22 are complementary in shape to each other, so that the lower restricting portion 512 is disposed in the restricting recess 224 in a way that their shapes exactly match. In this way, the restricting member 51 is disabled from rotating relative to the shaft 22. However, the lower restricting portion 512 of the restricting member 51 and the restricting recess 224 of the shaft 22 may be configured being not completely complementary in shape to each other. For example, the restricting recess 224 may be a little wider than the lower restricting portion 512 to enable the restricting member 51 to rotate relative to the shaft 22 in a small angle range. Such situation is also included when it is mentioned in the present invention that the rotation is restricted. When the restricting member 51 is located at the release position P2, as shown in FIG. 8, the restricting member 51 is pushed by the elastic member 53 so that the lower restricting portion 512 leaves the restricting recess 224. In this status, the rotation of the second jaw 40 and the restricting member 51 is not restricted by the restricting recess 224.

The shape design of the lower restricting portion 512 of the restricting member 51 and the restricting recess 224 of the shaft 22 is unlimited to that provided in this embodiment, as long as it brings the above-described rotation restricting effect. The restricting member 51 is also unlimited to have the axle portion 513, and the shaft 22 is unlimited to have the accommodating hole 225 for the axle portion 513 to be inserted therein. However, the design in this embodiment has the advantages of being simple in structure and easy in manufacture and assembly. Besides, the lower restricting portion 512 includes the two protrusions 517 located on two opposite sides of the axle portion 513 and correspondingly disposed in the two sections 228 of the restricting recess 224 located on two opposite sides of the accommodating hole 225. Such design makes structural strength and the rotation restricting effect even better. In addition, the axle portion 513 is inserted in the accommodating hole 225, that can ensure the restricting member 51 to positively move upward and downward to avoid slant. The elastic member 53 is disposed in the accommodating hole 225 and sleeved onto the rod portion 522 of the bolt 52, that can ensure the elastic member 53 to be positively lengthened and shortened upward and downward to avoid slant.

As shown in FIGS. 4 and 6, the restricting device 50 may, but unlimited to, further include a stopping member 54, and at least one fastening member 55 fastening the stopping member 54 to the second jaw 40. As shown in FIGS. 7 and 8, the stopping member 54 is partially located above the installation recess 45 of the second jaw 40 and the upper restricting portion 511 of the restricting member 51, thereby restricting the restricting member 51 in the installation recess 45. The stopping member 54 has an opening 541 for the bolt 52 to pass therethrough. As a result, when the user loosens the bolt 52, the bolt 52 can pass through the opening 541 of the stopping member 54 to move upwardly, but the upper restricting portion 511 cannot further move upwardly after contacting the stopping member 54. In this way, the elastic member 53 and the restricting member 51 are prevented from popping up to the outside of the installation recess 45 when the user loosens the bolt 52 too much.

It can be known from the above description that the user can rotate the bolt 52 to change the position of the restricting member 51 between the restricting position P1 and the release position P2. When the restricting member 51 is located at the restricting position P1 as shown in FIG. 7, the lower restricting portion 512 of the restricting member 51 is connected with the restricting recess 224 of the shaft 22, so the restricting member 51 and the second jaw 40 are disabled from rotating relative to the shaft 22 or only rotatable in a small angle range. When the restricting member 51 is located at the release position P2, the lower restricting portion 512 of the restricting member 51 leaves the restricting recess 224 of the shaft 22, so the restricting member 51 and the second jaw 40 are not restricted by the shaft 22 and thereby rotatable freely.

As a result, in the condition as shown in FIG. 12 that the workpiece 70 is shorter in length than the clamping surface 411 of the second jaw 40, the user can firstly loosen the bolt 52 to locate the restricting member 51 at the release position P2 to enable the second jaw 40 to rotate freely, then adjust the second jaw 40 to the required angle, and then screwinly tighten the bolt 52 to locate the restricting member 51 at the restricting position P1. That means in FIG. 12, the direction of the clamping surface 411 of the second jaw 40 is fixed, and thereby will not change due to the contact with the workpiece 70, or the second jaw 40 will only slightly swing in a specific small angle range. In this way, the second jaw 40 is prevented from rotating in the wrong direction when contacting a corner 71 of the workpiece 70, so the first and second jaws 30 and 40 can be set at the required angle to clamp the workpiece 70, thereby bringing great clamping effect. On the contrary, in the condition as shown in FIG. 13 that the length of the workpiece 70 is larger than the length of the clamping surface 411 of the second jaw 40, the user only needs to loosen the bolt 52 to locate the restricting member 51 at the release position P2 to set the second jaw 40 in the freely rotatable status, so that the second jaw 40 can automatically rotate in coordination with the angle of the workpiece surface in contact with the second jaw, thereby firmly abutted on the workpiece surface to make the workpiece 70 fixedly clamped by the first and second jaws 30 and 40.

As described above, the angularly adjustable vise 10 may use the restricting device 50 and/or the transversely moving type restricting device 60. The transversely moving type restricting device 60 is similar in function to the restricting device 50, and only one of them being used can change the status of the second jaw 40 between the freely rotatable status and the rotationally restricted status. However, using both of them can raise the effect of restricting the rotation of the second jaw 40. The structure and effect of the transversely moving type restricting device 60 will be specified hereinafter.

As shown in FIGS. 2 and 3, the transversely moving type restricting device 60 includes a transversely moving type restricting member 61, and two fastening members 62. The transversely moving type restricting member 61 includes a main plate 611 extending into a long shape along another imaginary horizontal axis L3, a hold portion 612 integrally extending from a short side of the main plate 611 perpendicularly to the main plate 611, an elongated installation groove 613 and two elongated fastening grooves 614, which penetrate through the main plate 611, and two stopping sheets 615 and 616 extending from two sides of the elongated installation groove 613 respectively. The imaginary horizontal axis L3 is perpendicular to the imaginary horizontal axis L1 and the imaginary vertical axis L2. The elongated installation groove 613 and the elongated fastening grooves 614 all extend into a long shape along the imaginary horizontal axis L3, and the elongated installation groove 613 is located between the two elongated fastening grooves 614. The transversely moving type restricting member 61 is disposed between the upper and lower installation portions 42 and 43 of the second jaw 40. The fastening members 62 are respectively inserted through the elongated fastening grooves 614 and fixedly screwed into threaded holes 46 of the second jaw 40, so that the transversely moving type restricting member 61 is detachably fastened to the second jaw 40. The end portion 211 of the linearly moving member 21 is inserted through the elongated installation groove 613.

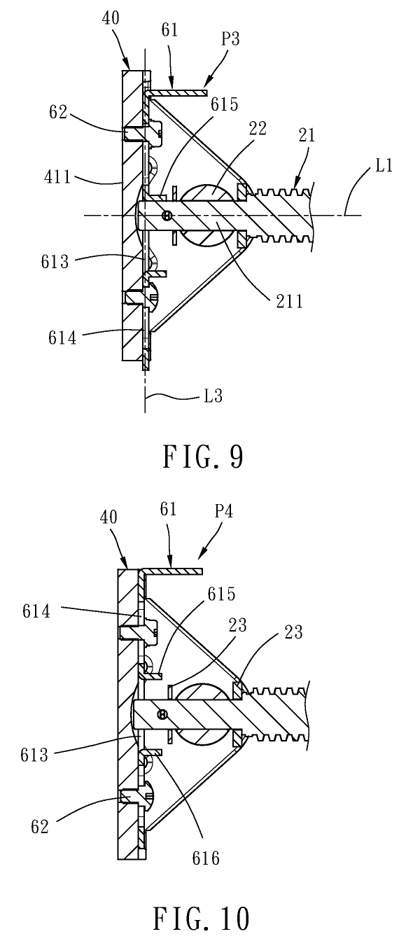

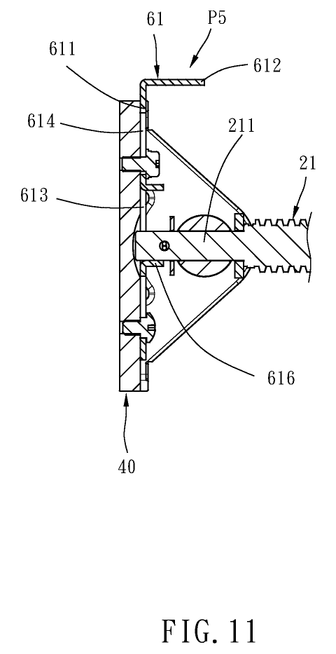

When the fastening members 62 are slightly loosened, the user can hold the hold portion 612 of the transversely moving type restricting member 61 to move the transversely moving type restricting member 61 along the imaginary horizontal axis L3. Therefore, the position of the transversely moving type restricting member 61 disposed on the second jaw 40 can be changed between a restricting position P3 as shown in FIG. 9 and a release position P4 as shown in FIG. 10, and also can be changed between the release position P4 and another restricting position P5 as shown in FIG. 11. When the position of the transversely moving type restricting member 61 is changed between the restricting position P3 and the release position P4 or between the release position P4 and the restricting position P5, the end portion 211 of the linearly moving member 21 slides along the elongated installation groove 613, and the fastening members 62 slide along the elongated fastening grooves 614 respectively.

When the transversely moving type restricting member 61 is located at the restricting position P3 as shown in FIG. 9, the stopping sheet 615 is abutted against the end portion 211 of the linearly moving member 21. In this status, the transversely moving type restricting member 61 and the second jaw 40 are restricted by the end portion 211 of the linearly moving member 21 from rotating clockwise. In the condition as shown in FIG. 12, as long as the second jaw 40 is restricted from rotating clockwise, the second jaw 40 is prevented from wrong rotation due to contact with the corner 71 of the workpiece 70. When the transversely moving type restricting member 61 is located at the restricting position P5 as shown in FIG. 11, the stopping sheet 616 is abutted against the end portion 211 of the linearly moving member 21. In this status, the transversely moving type restricting member 61 and the second jaw 40 are restricted by the end portion 211 of the linearly moving member 21 from rotating counterclockwise. The user can choose to dispose the transversely moving type restricting member 61 at the restricting position P3 or the restricting position P5 according to usage requirement, so as to restrict the rotation of the second jaw 40 in different directions. When the transversely moving type restricting member 61 is located at the release position P4 as shown in FIG. 10, the stopping sheets 615 and 616 are both separated from the end portion 211 of the linearly moving member 21. In this status, the rotation of the transversely moving type restricting member 61 and the second jaw 40 is not restricted by the end portion 211 of the linearly moving member 21, so the second jaw 40 is rotatable freely. Besides, the user can dispose the transversely moving type restricting member 61 at any position between the restricting position P3 or P5 and the release position P4 to make the transversely moving type restricting member 61 and the second jaw 40 still rotatable in the rotationally restricted direction in a small angle range. The transversely moving type restricting member 61 may have only one of the stopping sheets 615 and 616, as long as the rotation in a specific direction is restricted.

As a result, the transversely moving type restricting device 60 can bring the same effect with the restricting device 50 for the user to set the second jaw 40 in the freely rotatable status or restrict the second jaw 40 to a specific angle or angle range, thereby achieving great clamping effect under different workpiece setting angles and different workpiece lengths.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An angularly adjustable vise comprising:
a base;
a first jaw disposed on the base;
a moving device comprising a linearly moving member and a shaft, the linearly moving member being disposed on the base movably by being operated by a user, the shaft being disposed on the linearly moving member movably along with the linearly moving member, the shaft comprising an upper surface and a restricting recess recessed from the upper surface;
a second jaw sleeved onto the shaft rotatably relative to the shaft, the second jaw comprising an axial hole and an installation recess located at an end of the axial hole, the shaft being disposed in the axial hole; and
a restricting device comprising a restricting member, a bolt and an elastic member, the restricting member comprising an upper restricting portion, a lower restricting portion and a through hole, the restricting member being disposed in the installation recess in a way that rotation of the second jaw is restricted by the restricting member, the bolt comprising a head portion disposed on the upper restricting portion and a rod portion inserted through the through hole, the rod portion comprising a threaded section, the threaded section being screwed into a threaded hole in the shaft, the elastic member being disposed between the shaft and the restricting member in a way that the restricting member is pushed toward the head portion of the bolt by the elastic member;
wherein the bolt is movable relative to the shaft by being rotated by the user, so as to make the restricting member moved between a restricting position and a release position; when the restricting member is located at the restricting position, the lower restricting portion is located in the restricting recess of the shaft to cause rotation of the restricting member and the second jaw restricted by the restricting recess; when the restricting member is located at the release position, the restricting member is pushed by the elastic member to make the lower restricting portion leave the restricting recess.

2. The angularly adjustable vise as claimed in claim 1, wherein the restricting device further comprises a stopping member; the stopping member is fixed to the second jaw and partially located above the installation recess and the restricting member to restrict the restricting member in the installation recess; the stopping member has an opening for the bolt to pass therethrough.

3. The angularly adjustable vise as claimed in claim 1, wherein the upper restricting portion of the restricting member is complementary in shape to the installation recess of the second jaw so that the second jaw is disabled from rotating relative to the restricting member.

4. The angularly adjustable vise as claimed in claim 1, wherein the lower restricting portion of the restricting member is complementary in shape to the restricting recess of the shaft; when the lower restricting portion of the restricting member is located in the restricting recess, the restricting member is disabled from rotating relative to the shaft.

5. The angularly adjustable vise as claimed in claim 1, wherein the upper restricting portion of the restricting member comprises a circular section, and a lateral protrusion extending from a periphery of the circular section; the installation recess of the second jaw comprises a circular hole, and a lateral groove located on a side of the circular hole and communicating with the circular hole; the circular section and the lateral protrusion of the upper restricting portion of the restricting member are located in the circular hole and the lateral groove of the installation recess of the second jaw respectively.

6. The angularly adjustable vise as claimed in claim 5, wherein the restricting member comprises an axle portion extending from a lower surface of the circular section of the upper restricting portion; the through hole penetrates through the circular section and the axle portion; the shaft comprises an accommodating hole located between the upper surface and the threaded hole; the axle portion of the restricting member is inserted in the accommodating hole; the rod portion of the bolt is inserted through the accommodating hole.

7. The angularly adjustable vise as claimed in claim 6, wherein the elastic member is sleeved onto the rod portion of the bolt and disposed in the accommodating hole; the accommodating hole has a supporting surface connected with the threaded hole; two ends of the elastic member are disposed on the supporting surface of the shaft and the axle portion of the restricting member respectively.

8. The angularly adjustable vise as claimed in claim 6, wherein the lower restricting portion of the restricting member comprises two protrusions extending from the lower surface of the circular section of the upper restricting portion; the two protrusions are located on two opposite sides of the axle portion of the restricting member; one of the two protrusions is connected with the lateral protrusion of the upper restricting portion; the restricting recess of the shaft comprises two sections extending from two opposite sides of the accommodating hole; when the restricting member is located at the restricting position, the two protrusions of the lower restricting portion of the restricting member are located in the two sections of the restricting recess of the shaft respectively.

9. The angularly adjustable vise as claimed in claim 1, wherein the first jaw comprises a main body, a rotation axle inserted in the main body and the base, and an adjusting member; the main body comprises an arc groove; the adjusting member is inserted in the arc groove of the main body and the base capably of being tightened and loosened by the user; when the adjusting member is loosened, the main body is rotatable by the user in a way that the adjusting member slides in the arc groove; when the adjusting member is tightened, the main body is fixed to the base.

10. The angularly adjustable vise as claimed in claim 1, wherein the angularly adjustable vise further comprises a transversely moving type restricting device; the transversely moving type restricting device comprises a transversely moving type restricting member; the transversely moving type restricting member is disposed on the second jaw in a way that position of the transversely moving type restricting member is changeable between a restricting position and a release position; when rotating relative to the shaft, the second jaw rotates around an imaginary vertical axis; the transversely moving type restricting member comprises an elongated installation groove extending into a long shape perpendicularly to the imaginary vertical axis, and at least one stopping sheet extending from at least one side of the elongated installation groove; an end portion of the linearly moving member is inserted in the elongated installation groove; when the position of the transversely moving type restricting member is changed between the restricting position and the release position thereof, the end portion of the linearly moving member slides along the elongated installation groove; when the transversely moving type restricting member is located at the restricting position thereof, the stopping sheet is abutted against the end portion of the linearly moving member to restrict the transversely moving type restricting member and the second jaw from rotating in a specific direction; when the transversely moving type restricting member is located at the release position thereof, the stopping sheet is separated from the end portion of the linearly moving member.

11. The angularly adjustable vise as claimed in claim 10, wherein the transversely moving type restricting member comprises two said stopping sheets extending from two said sides of the elongated installation groove respectively; when one of the stopping sheets is abutted against the end portion of the linearly moving member, the transversely moving type restricting member and the second jaw are restricted from rotating clockwise; when the other stopping sheet is abutted against the end portion of the linearly moving member, the transversely moving type restricting member and the second jaw are restricted from rotating counterclockwise.

12. The angularly adjustable vise as claimed in claim 10, wherein the transversely moving type restricting member further comprises at least one elongated fastening groove extending into a long shape perpendicularly to the imaginary vertical axis; the transversely moving type restricting device further comprises at least one fastening member; the fastening member is inserted in the elongated fastening groove and detachably fastened to the second jaw.

13. An angularly adjustable vise comprising:
a base;
a first jaw disposed on the base;
a moving device comprising a linearly moving member and a shaft, the linearly moving member being disposed on the base movably by being operated by a user, the shaft being disposed on the linearly moving member movably along with the linearly moving member;
a second jaw disposed on the shaft rotatably relative to the shaft; and
a restricting device comprising a restricting member, the restricting member being disposed on the second jaw in a way that position of the restricting member is changeable between a restricting position and a release position, when the restricting member is located at the restricting position, a part of the restricting member being connected with the moving device so that rotation of the restricting member and the second jaw is restricted by the moving device, when the restricting member is located at the release position, the part of the restricting member being separated from the moving device.

14. The angularly adjustable vise as claimed in claim 13, wherein the restricting device is a transversely moving type restricting device, and the restricting member thereof is a transversely moving type restricting member; when rotating relative to the shaft, the second jaw rotates around an imaginary vertical axis; the transversely moving type restricting member comprises an elongated installation groove extending into a long shape perpendicularly to the imaginary vertical axis, and at least one stopping sheet extending from at least one side of the elongated installation groove; an end portion of the linearly moving member is inserted in the elongated installation groove; when the position of the transversely moving type restricting member is changed between the restricting position and the release position, the end portion of the linearly moving member slides along the elongated installation groove; when the transversely moving type restricting member is located at the restricting position, the stopping sheet is abutted against the end portion of the linearly moving member to restrict the transversely moving type restricting member and the second jaw from rotating in a specific direction; when the transversely moving type restricting member is located at the release position, the stopping sheet is separated from the end portion of the linearly moving member.

15. The angularly adjustable vise as claimed in claim 14, wherein the transversely moving type restricting member comprises two said stopping sheets extending from two said sides of the elongated installation groove respectively; when one of the stopping sheets is abutted against the end portion of the linearly moving member, the transversely moving type restricting member and the second jaw are restricted from rotating clockwise; when the other stopping sheet is abutted against the end portion of the linearly moving member, the transversely moving type restricting member and the second jaw are restricted from rotating counterclockwise.

16. The angularly adjustable vise as claimed in claim 14, wherein the transversely moving type restricting member further comprises at least one elongated fastening groove extending into a long shape perpendicularly to the imaginary vertical axis; the transversely moving type restricting device further comprises at least one fastening member; the fastening member is inserted in the elongated fastening groove and detachably fastened to the second jaw.
